(19) United States
(12) Patent Application Publication
(10) Pub. No.: US 2003/0169306 A1
(43) Pub. Date: Sep. 11, 2003

(54) Creating a screen saver from downloadable applications on mobile devices

(75) Inventors: Mikko Makipaa, Helsinki (FI); Toni Kopra, Sooritie (FI); Hemant Madan, Espoo (FI); Akseli Anttila, Helsinki (FI); Petteri J. Saarinen, Helsinki (FI); Barbara Heikkinen, Espoo (FI); Oleg Beletski, Helsinki (FI)

Correspondence Address: BANNER & WITCOFF, 1001 G STREET N W, SUITE 1100, WASHINGTON, DC, 20001, US

(73) Assignee: NOKIA CORPORATION, ESPOO (FI)

(21) Appl. No.: 10/092,261

(22) Filed: Mar. 7, 2002

(51) Int. Cl. G09G 5/00

(52) U.S. Cl. 345/864; 345/867

(57) ABSTRACT

A screen saver is provided for an apparatus having a display screen, a storage medium, a computer application stored in the storage medium, and a screen saver program stored in the storage medium. The application has a handle that executes the application in a screen saver mode when it is selected. The handle is contained in a carousel, which includes a database containing the handles. The database also includes rules for selecting the handles and parameters associated with each handle. When a timeout period of inactivity is exceeded on the apparatus, the screen saver program is executed. The screen saver program selects the application handle from the carousel, which executes the application in the screen saver mode. While operating in the screen saver mode, the application creates images that are shown on the display screen.

### FIELD OF THE INVENTION

This invention relates generally to mobile communication devices. More particularly, the present invention relates to a device having a screen saver program stored thereon that manages applications to operate in a screen saver mode.

### BACKGROUND OF THE INVENTION

Screen saver programs are well known in the art for use on conventional computers. These programs conventionally serve various functions, including prevention of burn-in on cathode ray tube (CRT) screens, saving power, and providing decorative views.

Additional functions have also been proposed for these programs. For example, screen saver programs have been proposed that provide useful information, such as providing contact information for an operator associated with a particular computer (e.g. the operator's mobile telephone number, the operator's location for a time period, etc.) or for providing the current time.

Interactive screen saver programs have also been proposed. These programs, for example, may display a text message received by a computer while operating a screen saver program. As another example, an interactive screen saver program may permit a person to request that a message be sent to a designated pager while remaining in screen saver mode. Many of the screen savers proposed, therefore, are able to modify their displays based, for example, on the reception of information or on interactive inputs. The screen saver programs proposed, however, have been limited to displaying the types of views for which they have been specifically programmed. For example, although a text message screen saver program can display an infinite number of different messages, it can only display a limited number of message types according to its programming. It cannot display the current time or paging information if it has not been programmed to do so. In other words, these screen saver programs are limited to their programmed displays.

Screen saver programs have also been proposed for wireless mobile communication devices. Because these devices do not need protection from burn-in associated with CRTs, they are typically designed to save battery power or to display information such as wireless signal strength, date, time, etc. Screen saver programs on these devices are typically less functional than screen savers for larger computing devices; however, like programs for larger devices, they are limited in their functionality according to their particular programming.

### SUMMARY OF THE INVENTION

The present invention provides a system and method for creating a screen saver from one or more applications. Thus, a device operating in a screen saver mode according to the present invention is able to perform an unlimited number of functions and to display an unlimited number of display types by executing other applications. Operation of the device in screen saver mode is only limited by the other applications invoked by a screen saver program. Because the screen saver uses other applications, it is easier to develop the screen saver program, which may also take less storage space than conventional screen saver programs. By invoking other applications, the screen saver program can use functions and settings inherent to those applications, such as settings that may be needed for secure transmissions or for access to certain websites.

In one embodiment, the present invention includes a computing apparatus having a display screen, a storage medium, a computer application stored in the storage medium, and a screen saver program stored in the storage medium. The application has at least one handle that executes the application in a screen saver mode when it is selected. The application is a program that operates in a full application mode on the apparatus, but that is configured to also operate with reduced functionality in the screen saver mode. When a timeout period of inactivity is exceeded on the device or apparatus, the screen saver program is executed. The screen saver program selects the application handle, which executes the application in the screen saver mode. While operating in the screen saver mode, the application creates images that are shown on the display screen.

According to one aspect of the invention, the device includes a carousel containing the at least one application handle. Preferably, the apparatus includes a number of applications that have been configured for operation in a screen saver mode and further includes more than one handle for many of the applications. Each handle is preferably associated with operation of an associated application in a different screen saver mode. The screen saver carousel contains the handles for applications an operator desires the screen saver to execute during its operation. The carousel preferably includes a database stored in the storage medium that includes the handles, rules for selecting the handles, and parameters associated with each handle. The rules, which generally determine when each handle is executed in the screen saver mode, are preferably definable by the operator. The parameters, which generally control some operational aspects of the associated application in the screen saver mode according to the particular handle, are also preferably definable by the operator.

In another aspect of the invention, the apparatus is in communication with a network and at least one application is configured to display current information based on data received through the network. Preferably, the at least one application is continually updated during operation in response to reception of data from the network, so that the most current data is continually displayed. According to another aspect of the invention, the apparatus is a wireless communication device.

A method for creating screen saver displays according to the present invention includes the steps of creating an application handle, adding the application handle to the screen saver carousel, starting the screen saver program, and selecting the application handle. Preferably, the method further includes the steps of installing the application on the apparatus, and selecting an option during installation for the application to operate in a screen saver mode. For applications not set up for a screen saver mode during installation, or to set up another application handle for an application, the method preferably further includes the steps of executing the application in a full application mode and selecting an option for installing a screen saver mode.

In another aspect of the invention, the method preferably includes the steps of monitoring the apparatus for input from a command entry device, or monitoring the apparatus for a timeout signal while an application is operating in a screen saver mode. If a timeout signal is received, the method further includes the step of executing another application to operate in a screen saver mode. If the device detects input from the command entry device, the method further includes the step of determining whether the application operating in a screen saver mode is interactive. If it is not interactive, the screen saver terminates and the device returns to normal functionality. If the application is interactive and if the input detected corresponds to an interactive function of the application, the method includes the step of executing the application in full application mode.

In other embodiments of the invention, computer-executable instructions for implementing the disclosed methods are stored on computer-readable media.

Other features and advantages of the invention will become apparent with reference to the following detailed description and figures.

### BRIEF DESCRIPTION OF THE DRAWINGS

FIG. 1 shows an exemplary layout of a system according to the present invention including a wireless communication device or apparatus in communication with a network;

FIG. 2 shows a functional block diagram of the device of FIG. 1;

FIG. 3 shows a flow diagram for creating a screen saver according to the present invention depicting steps for configuring an application for operation in a screen saver mode during installation of the application;

FIG. 4 shows a flow diagram for creating a screen saver according to the present invention depicting steps for configuring an installed application for operation in a screen saver mode;

FIG. 5 shows a flow diagram depicting steps for operating a screen saver on a device according to one embodiment of the present invention;

FIG. 6 shows sample screen views according to operation of an application in a full application mode on a device according to the present invention;

FIG. 7 shows sample screen views according to operation of the application of FIG. 6 in a screen saver mode;

FIG. 8 shows sample screen views according to operation of a different application from FIGS. 6 & 7 in a full application mode on a device according to the present invention;

FIG. 9 shows sample screen views according to operation of the application of FIG. 8 in a screen saver mode.

### DETAILED DESCRIPTION OF THE INVENTION

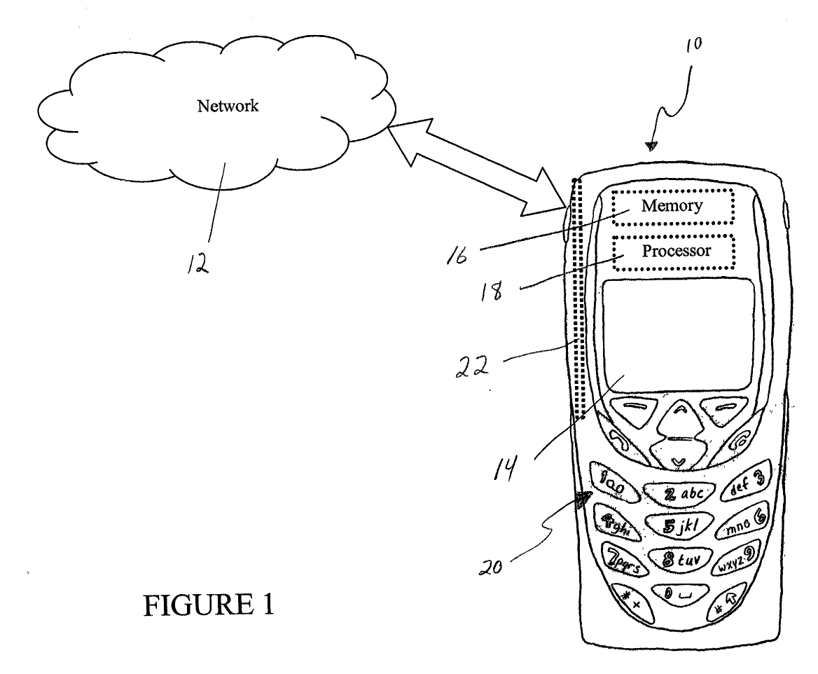

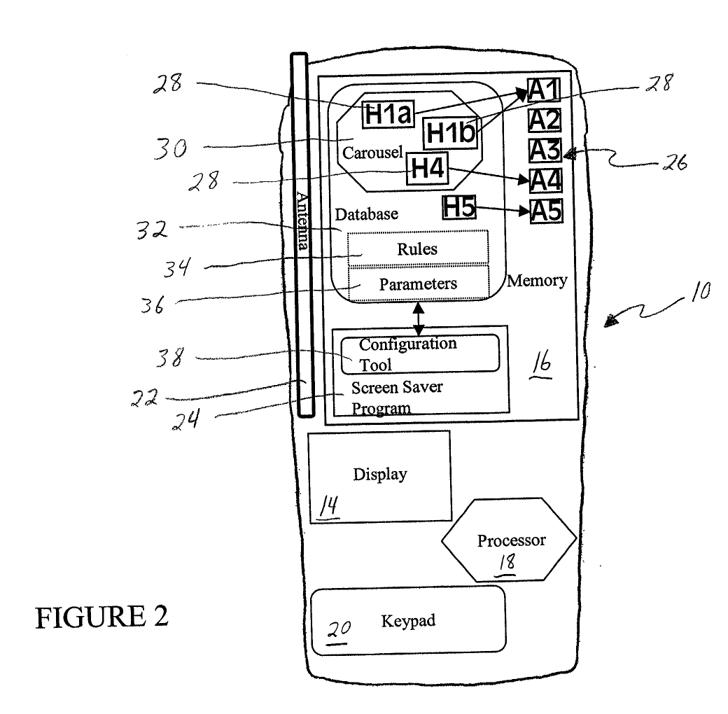

The invention may be embodied in various forms. One embodiment of the present invention includes an apparatus or device as shown in FIGS. 1 and 2. The apparatus for displaying screen saver views according to this embodiment is a wireless communication device 10; however, it is appreciated that the apparatus could be one of many different types of computing devices, such as a desktop, laptop, or handheld computer. According to this embodiment, the device 10 is in communication with a wireless network 12 via a wireless communication system as is known in the art. The device 10 generally includes a display screen 14, a memory 16, a processor 18, a keypad 20, and an antenna 22.

The display screen 14 displays text and/or graphics and may include, for example, a liquid crystal display (LCD) screen. The memory 16 is a storage medium for storing data that, in this embodiment, includes nonvolatile memory such as flash memory for storing downloadable programs, random access memory for operating the programs, and read-only memory for storing operating instructions and pre-installed programs; however, other types of media for storing data could be used. The processor 18 performs operations for the device in accordance with instructions from software stored in the memory. The keypad 20 is a type of command entry device common in the art that permits an operator to interact with the device and provide commands for operation of the device. Other types of command entry devices may include a microphone for receiving voice commands, a touch screen, mouse, etc. The antenna 22 transmits and receives signals between other devices or stations in the wireless network 12 as is known in the art.

Stored in the memory 16 of the wireless communication device 10 are a number of applications 26 designated in FIG. 2 as A1-A5, a carousel 30, and a screen saver program 24. An application as used herein is generally a computer program that has a full application mode independent of the screen saver program. In other words, an application may operate on the device independent of the state of the screen saver program. An application and the screen saver program may share access to certain routines, such as application program interfaces (API) or dynamic link library (DLL) files; however, they are both independent programs. The screen saver program may control an application in the sense that it may execute or close the application or provide operational parameters, but otherwise the application generally controls its own operation. The device 10 includes a plurality of applications; however, only 3 of the sample applications include a screen saver handle 28 (shown as H1a, H1b, H4 and H5 in FIG. 2). Two of these handles, and H1b, are associated with the same application A1.

A screen saver handle 28 activates a corresponding application in a screen saver mode of the application. In the screen saver mode, the application operates with reduced functionality compared with the full application mode of the application. A single application may have more than one handle (see H1a and H1b in FIG. 2), in which case each handle activates the same application in a different reduced functionality mode or with different operating parameters (discussed below). The applications may be configured by the operator to operate in various screen saver modes according to the options of the application. In one embodiment, the device is a Java™ 2 Micro Edition (J2ME®) capable mobile device as is known in the art, meaning the device can operate as a virtual machine for the Java™ platform. Accordingly, the applications according to this embodiment include programs written for the J2ME® platform, and include applications downloaded from the network 12. For instance, A1 may comprise a web browser application, A2 may comprise a game application, A3 may comprise a scheduling application, A4 may comprise a stock ticker application, and A5 may comprise a photo-viewing application.

The carousel 30 comprises a set of locations in the memory 16 where the handles of applications to be executed during operation of the screen saver program are stored. According to this embodiment, the carousel 30 is part of a database 32 stored in the memory 16. The carousel 30 contains certain ones of the handles 28 that a user desires to be selected by the screen saver program 24. The database 32 also contains rules 34 for selecting the handles 28 and parameters 36 for executing applications associated with the handles. The handles 28 contained in the carousel are the handles associated with applications chosen by the operator for execution during operation of the screen saver program.

The screen saver program 24 comprises a program that in operation manages the execution of applications in their screen saver modes. It accomplishes this by selecting in turn each of the handles 28 contained in the carousel 30. The scheduling and timing of those applications is governed by the rules 34 in the database. The rules could, for example, be as simple as time slices, or be complex, such as prioritizing based on information available with the application at the current time. The rules 34 could be default rules or the user could change these rules, thus varying the look and feel of the screen saver.

When the screen saver program selects a handle to execute an associated application in a screen saver mode, the application is executed according to parameters 36 whose values are configured by the user. Additionally, the parameters 36 may be based on the rules 34. For example, a stock ticker application A4 could have a parameter URL that defines from where to get the stock data. This parameter could have different values based on the time of the day and may be configured by the user. For instance, the user could choose a parameter URL associated with data from the New York Stock Exchange® for certain hours of the day and another parameter URL associated with data from the Helsinki Stock Exchange for other hours of the day. The parameters could also indicate certain stock symbols to monitor during certain times or days.

According to one embodiment, the screen saver program includes a configuration tool 38 that permits the user to modify the rules 34 and the parameters 36 contained in the database 32. When the configuration tool 38 of the screen saver program is executed, such as from a toolbar or other link for executing the configuration tool, a user can modify the rules 34 and parameters 36 for each application handle 28. Accordingly, a user can change the look and operation of the screen saver for the device by simply changing the rules 34 and parameters 36 for each application handle 28 in the carousel 30, and by deleting and adding existing handles in the carousel. Although the configuration tool is part of the screen saver program in this embodiment, it could be a completely different database editor program as is known in the art, or it could be a set of routines that the applications can invoke during set up in a screen saver mode, or other means for editing data in a database. In this embodiment, the user has removed handle H5 from the carousel even though application A5 has been set up to operate in a screen saver mode. The user could use the configuration tool 38 to add handle H5 to the carousel at a later time.

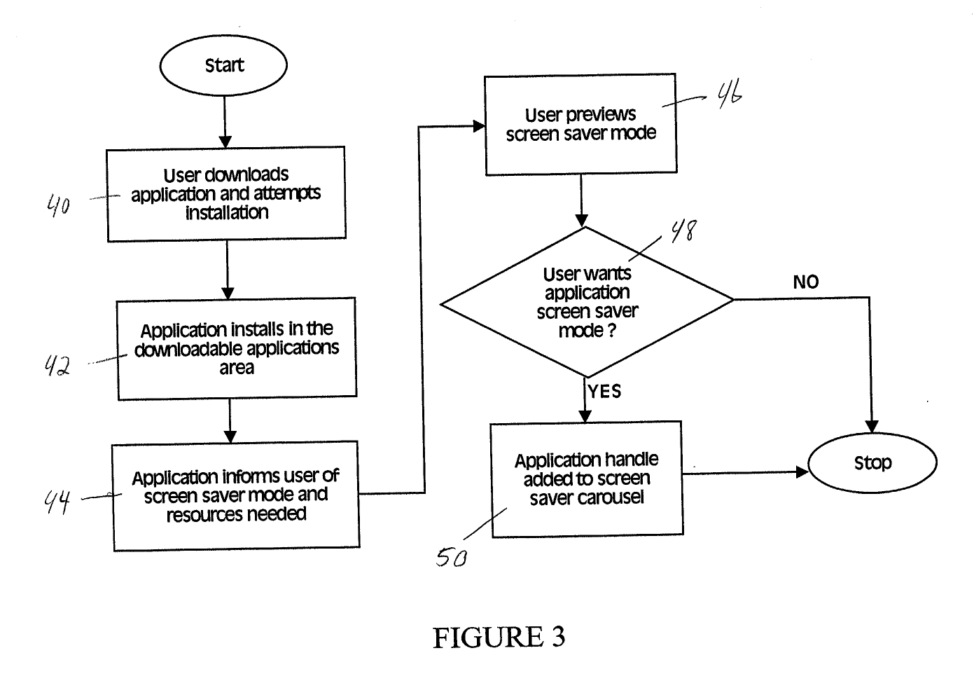

The user can also add new handles to the carousel by installing new applications and setting them up for operation in a screen saver mode, by setting up existing applications for operation in a screen saver mode, or by setting up additional screen saver modes for existing applications having an existing handle in the carousel. The steps for installing a new downloaded application on the device 10 and setting it up for operation in a screen saver mode according to this embodiment of the invention are shown in FIG. 3. Accordingly, the process starts with a user downloading 40 a new application and attempting to install the application on the device 10. The application is installed 42 into the memory 16, which is the area according to the present embodiment for storing applications. During installation, the application informs the user of the screen saver mode option and the resources needed 44 for operation in the screen saver mode (e.g. network access). The user previews 46 the screen saver mode and chooses 48 whether he wants the screen saver mode for the application. If the user chooses to have the screen saver mode, an application handle is created and added 50 to the screen saver carousel 30. If the user chooses not to have the screen saver mode, an application handle is not created and the process stops.

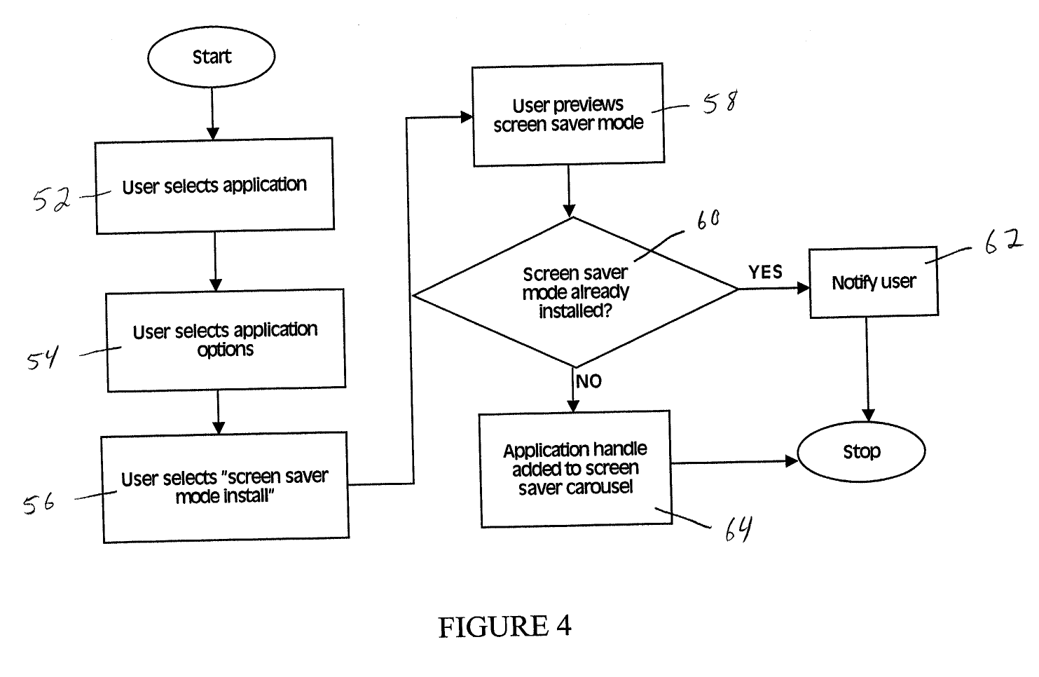

The steps for setting up an installed application for operation in a screen saver mode according to one embodiment of the invention are shown in FIG. 4. Accordingly, the process starts with the user selecting 52 and thereby executing the application to be set up. With the application in full application mode, the user selects 54 the menu choice related to the application's options, and selects 56 the choice for “screen saver mode install.” The user previews 58 the screen saver mode and chooses associated options if available. If the application does not have options beyond a single screen saver mode, then the user is not given the opportunity to choose options. If the application has options that may allow for more than one screen saver mode, then the user can choose associated options. These options, for example, may include the level of functionality of the application in a screen saver mode. In the example of the browser application A1, one screen saver mode according to selected options may permit the browser to be somewhat interactive, whereas another screen saver mode may only display views without interactivity. After the user previews the chosen or default screen saver mode, the application evaluates 60 the screen saver mode chosen to determine if it is already installed, and if it is, the application notifies 62 the user and the process stops. If the same screen saver mode for the selected options is not already installed, the application handle is added 64 to the screen saver carousel.

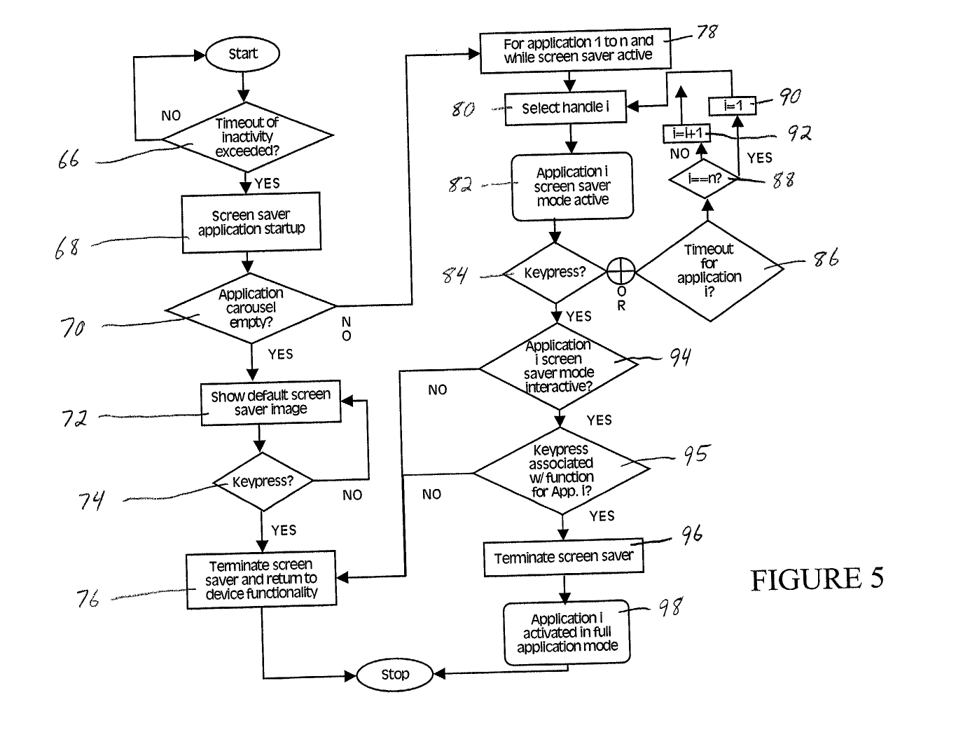

The operation of a screen saver according to one embodiment of the present invention is generally depicted in FIG. 5. Initially, the device 10 monitors 66 itself to determine if a period of inactivity has been exceeded. The device 10 according to this embodiment simply monitors inputs from the keypad 20; however, it could additionally monitor whether the device is involved in certain activities, such as a telephone call, or whether inputs are received from other command entry devices, such as a microphone. When a period of inactivity is exceeded, the device starts 68 the screen saver program 24. The screen saver program determines 70 whether the carousel is empty. If the carousel is empty, the screen saver program instructs the device to show 72 a default screen saver image on the display 14. The device monitors 74 the keypad 20 for input, and if a key from the keypad is pressed while the default screen saver image is being shown, the device terminates 76 the screen saver program 24, and the process stops. If a keypad is not pressed, the default screen saver images continue to be shown.

If the carousel is not empty, thus containing at least one application handle 28, instead of showing 72 a default screen saver image, the screen saver program enters an application selection loop 78. According to the selection loop 78, the screen saver program selects 80 a first handle according to rules 34 stored in the database 32, which activates 82 the application associated with the first handle. While the screen saver program is operating, the device 10 continues to monitor 84 the keypad 20 for input. At the same time, the screen saver program 24 monitors 86 the period that the first application operates. In accordance with the rules 34, when a timeout period for the first application is reached, the screen saver evaluates the priority for activating a different handle according to the rules 34. In one embodiment, the rules dictate that the applications be executed sequentially in a round robin fashion. Accordingly, the screen saver program determines 88 whether application currently in operation is the last one sequentially in the carousel 30. If the last sequential application is operating, the screen saver program 24 sets 90 an application selection counter i equal to 1; otherwise, the program 24 increments 92 the application selection counter i by 1. The screen saver returns to the step of selecting 80 an application handle according to the rules, which in this example, is according to the sequential application counter i.

As the screen saver program is managing applications, if the device 10 detects 84 input from the keypad 20, the screen saver program evaluates 94 whether the current application in operation is interactive. If it is interactive, the device 10 evaluates 95 whether the input from the keypad is associated with a function of the operating application. If so, the device 10 terminates 96 the screen saver program and the application operating in a screen saver mode is activated 98 in a full application mode. If the application operating is not interactive, or if the input detected is not associated with a function of the interactive operating application, the device 10 terminates 76 the screen saver program and the device returns to normal functionality.

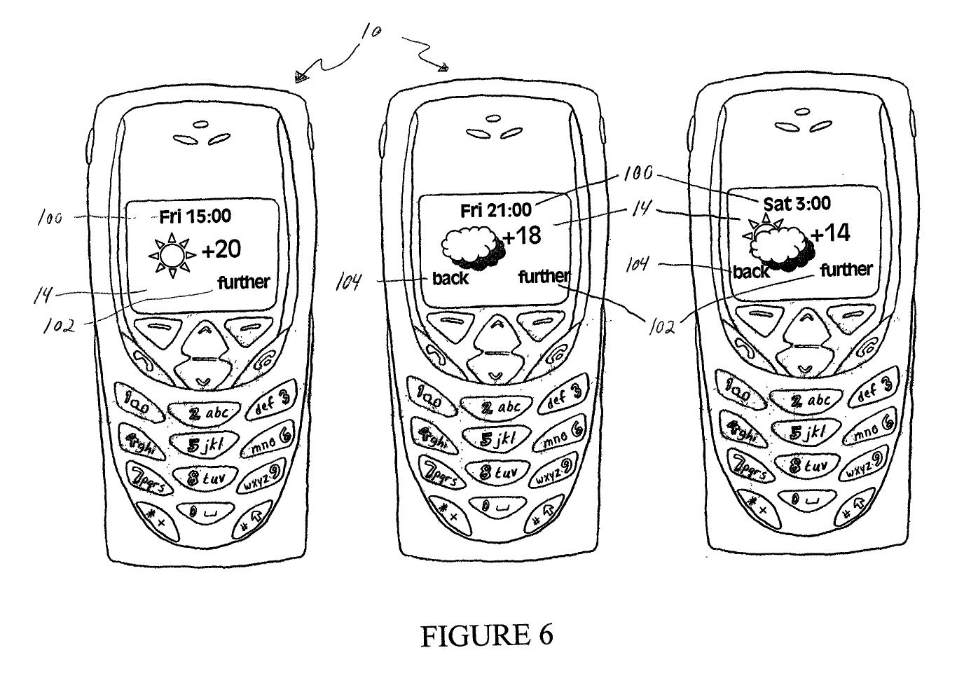

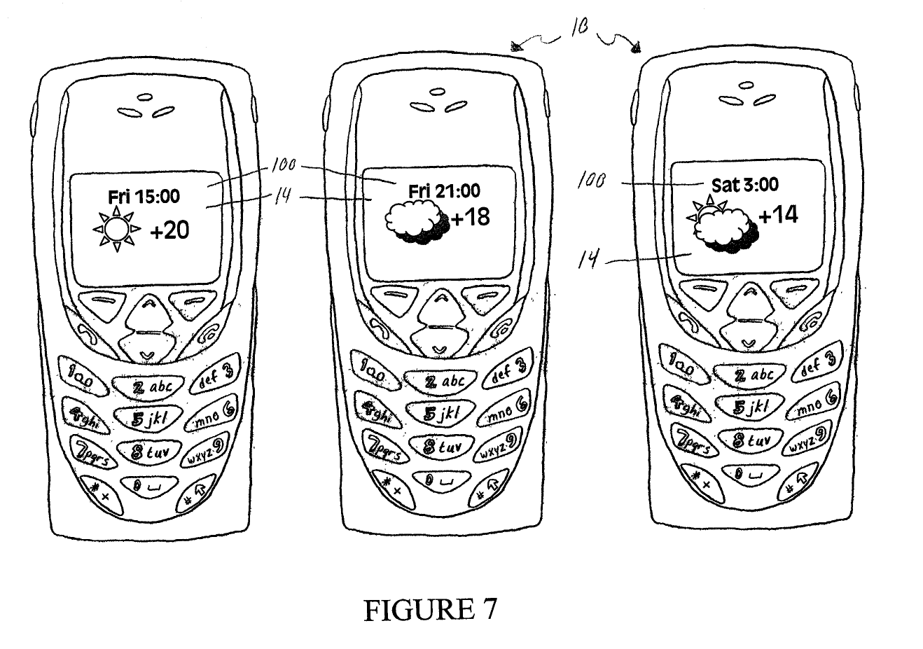

Referring now to FIGS. 6-9, sample screen views for a device 10 according to the present invention operating in a screen saver are shown. Consistent with the embodiment discussed previously, the sample screen views are created by application A1, which is a web browser application. In FIG. 6, application A1 is operating in a full application mode. In this mode, the user has directed the browser application to a web site via the network 12 providing current weather information. If left in the full application mode, the browser will show on the display 14 current weather information throughout the day as it receives new data. Note that the display 14 shows a time/date indicator 100. Additionally, it provides a further selector 102 and a back selector 104 for permitting the user to control browser views. In FIG. 7, handle H1a associated with application A1 has been selected by the screen saver program 24, and application A1 has been executed in a screen saver mode. The parameters 36 associated with handle H1a have directed the application A1 to the same website as FIG. 6 that provides weather information. Compared with the full application mode, the screen saver mode associated with handle H1a is not interactive. Thus, the application only displays current information, which may be updated as new information is received, but does not permit any user interaction. Note that the time/date indicator 100 is present, but that the further and back selectors 102, 104 are not present.

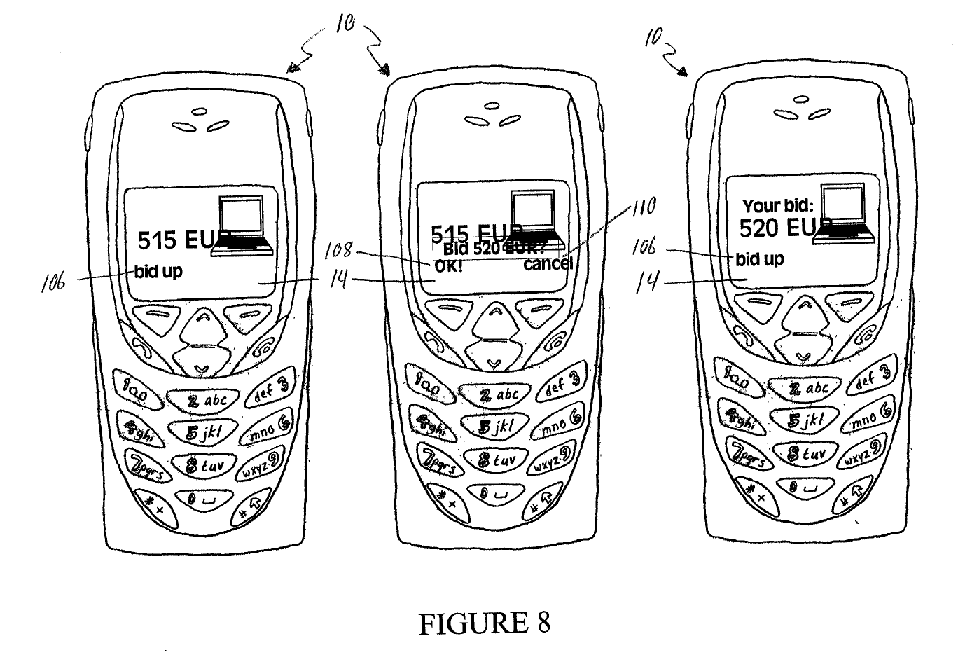

FIG. 8 represents application A1 operating again in full application mode, but this time the user has directed the browser to an auction web site via network 12. FIG. 8 demonstrates a user bidding on an item such as a laptop computer. Because application A1 is fully functional in this mode, the user can actively participate in the bidding process. Note that the display 14 includes various selectors. The bid up selector 106 permits the user to bid an amount greater than the previous bid. The OK selector 108 and the cancel selector 110 seek to confirm or cancel respectively the bid submission.

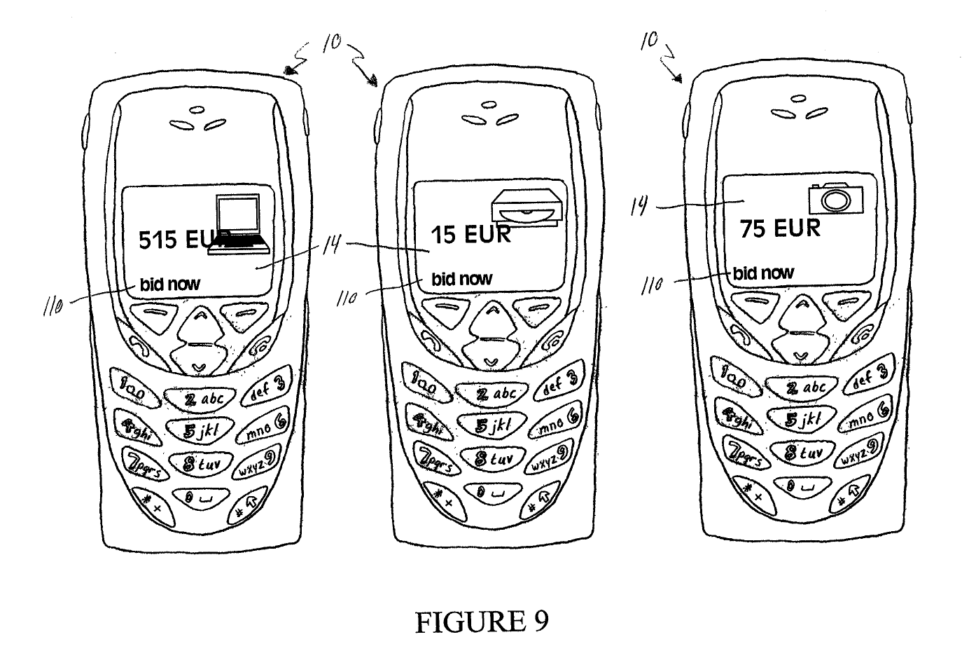

FIG. 9 represents application A1 operating in a screen saver mode. In this example, application A1 was executed by the screen saver program selecting handle H1b. In the screen saver mode that the user set up for handle H1b, the browser is more functional than the mode associated with handle H1a. Thus, the application A1 is partially interactive in this mode. As the application operates in this mode, it displays various bid items and their currant bid price; however, the application additionally provides the user the opportunity to indicate a desire to bid on a particular item. The bid now selector 110 permits the user to indicate to the device the desire to bid on the item shown in display 14. If the user presses a key on the keypad 20 associated with bid now selector 110, the application A1 is activated in full application mode. The user can therefore operate the functions of the application necessary to complete the bid process. If the user presses a key that is not associated with the options displayed in the screen saver mode, the screen saver is terminated and the device 10 returns to normal functionality.

While the present invention has been described in connection with the illustrated embodiments, it will appreciate and understood that modifications may be made without departing from the true spirit and scope of the invention.

I/we claim:

1. An apparatus for displaying screen saver views generated by a computer application operating in a screen saver mode, the apparatus comprising:
a storage medium; and
a processor coupled to the storage medium that performs the following steps:
(a) monitoring the apparatus for detecting inputs from a command entry device;
(b) determining whether a timeout period of inactivity from the inputs has been exceeded; and
(c) in response to step (b), executing an application in a screen saver mode, the application being a program that is fully functional in a full application mode and that is less than fully functional in a screen saver mode, the application creating images for presentation on a display screen in the screen saver mode.

2. The apparatus of claim 1, wherein the apparatus comprises a wireless communication device.

3. The apparatus of claim 1, wherein the apparatus further comprises a carousel stored in the storage medium, and an application handle stored in the carousel, the handle being associated with the application and executing the application in the screen saver mode.

4. The apparatus of claim 3, wherein the carousel comprises a database stored in the storage medium containing the application handle and rules for selecting the application handle.

5. The apparatus of claim 4, wherein the rules are definable by a user of the apparatus.

6. The apparatus of claim 4, wherein the rules comprise default rules.

7. The apparatus of claim 4, wherein the database further contains application execution parameters associated with the handle, wherein the application is executed in the screen saver mode according to the parameters associated with the handle selected for executing the application.

8. The display device of claim 7, wherein the application additionally has another handle comprising different execution parameters.

9. The apparatus of claim 1, wherein the apparatus is in communication with a network and displays current information generated by the application operating in the screen saver mode based on data received from the network.

10. The apparatus of claim 9, wherein the images are continually updated in response to data received from the network.

11. The apparatus of claim 1, wherein the processor further performs the step of (d) executing at least one additional application in a corresponding screen saver mode, the at least one additional application being a program that is fully functional in a corresponding full application mode and that is less than fully functional in a corresponding screen saver mode, the at least one additional application creating images for presentation on the display screen in the corresponding screen saver mode.

12. The apparatus of claim 11, wherein the processor cycles between performing steps (c) and (d) according to an order.

13. The apparatus of claim 12, wherein the order comprises rules for scheduling the execution of applications in their respective screen saver modes.

14. A wireless communication device, comprising:
a receiver;
a memory storing data;
a display screen;
at least one application stored in the memory having at least one handle executing the at least one application in a screen saver mode when the at least one handle is selected, the at least one application creating images for presentation on the display screen in the screen saver mode; and
a screen saver program stored in the memory that, during operation of the screen saver program, selects the at least one application handle.

15. The wireless communication device of claim 14, further comprising a carousel containing the at least one application handle.

16. The wireless communication device of claim 15, wherein the carousel comprises a database stored in the memory containing the at least one application handle and rules for selecting the at least one application handle.

17. The wireless communication device of claim 16, wherein the rules are definable by a user of the communication device.

18. The wireless communication device of claim 16, wherein the rules comprise default rules.

19. The wireless communication device of claim 16, wherein the database further contains application execution parameters associated with the at least one handle, wherein the at least one application is executed in a screen saver mode according to the parameters associated with the at least one handle selected for executing the at least one application.

20. The display device of claim 19, wherein the at least one application additionally has another handle associated with the at least one application, the another handle comprising different execution parameters.

21. The wireless communication device of claim 14, wherein the at least one application comprises a network application creating images responsive to data received during operation in the screen saver mode.

22. The wireless communication device of claim 21, wherein one of the parameters associated with the network application is a uniform resource locator (URL).

23. The wireless communication device of claim 14, wherein the device is a Java™ enabled platform and the at least one application is written for operation in a Java™ type architectural model.

24. A method of creating screen saver displays on a display device, the device having a display screen, a storage medium, a screen saver computer program stored in the storage medium, and a screen saver carousel stored in the storage medium, the method comprising the steps of:
adding an application handle to execute an application in a screen saver mode to the screen saver carousel;
starting the screen saver program in response to exceeding a timeout period of inactivity; and
selecting the application handle to execute the application in the screen saver mode.

25. The method of claim 24, further comprising the following steps:
installing the application on the display device; and
selecting an option for the application to operate in the screen saver mode.

26. The method of claim 24, wherein the application is pre-installed on the device, further comprising the following steps:
executing the application in a full application mode on the display device; and
selecting an option for installing a screen saver mode for the application to operate in the screen saver mode.

27. The method of claim 24, further comprising the steps of:
monitoring the display device for a timeout signal that the application has exceeded a time period allotted for operation in the screen saver mode; and
in response to detecting the timeout signal, if another application has been configured to operate in a screen saver mode, executing another application in a screen saver mode associated with the another application.

28. The method of claim 24, further comprising the steps of:
monitoring the display device for an input signal from a command entry; and
if a signal is received from the command entry device after the application has been executed, determining whether the executed application operating in the screen saver mode is an interactive application; and
if the executed application is an interactive program, terminating the screen saver program, and
executing the interactive program in a full application mode.

29. A computer readable medium having computer-executable instructions for performing steps comprising:
monitoring activity on a device having a display screen;
determining whether a timeout period of inactivity on the device has been exceeded;
evaluating whether a screen saver carousel contains application handles, each of the application handles executing a respective application in a screen saver mode when selected; and
if the carousel contains at least one application handle, and if the timeout period has been exceeded, selecting the at least one application handle to execute the respective application.

30. The computer readable medium of claim 29, wherein the activity being monitored is the detection of input signals from a command entry device in communication with the device, the steps further comprising:
if a signal is not received from the command entry device, if a timeout period for operation of the respective application is exceeded, and if the carousel contains more than one handle,
selecting a different handle to execute another respective application associated with the different handle.

31. The computer readable medium of claim 30, wherein the respective application associated with the at least one handle and the respective application associated with the different handle are the same application configured for operation in different screen saver modes depending on the handle selected.

32. The computer readable medium of claim 30, wherein the respective application associated with the at least one handle and the respective application associated with the different handle are different applications.

33. The computer readable medium of claim 29, wherein the activity being monitored is the reception of input signals from a command entry device in communication with the device, the steps further comprising:
if a signal is received from the command entry device after the respective application is executed, determining whether the respective application currently operating in the screen saver mode is an interactive application; and
if the respective application is an interactive program,
terminating the screen saver program, and
executing the respective interactive program in a full application mode.

34. A portable device comprising:
a display screen;
a memory;
a command entry device;
a computer application stored in the memory, the application having at least one handle executing the application in a screen saver mode when the at least one handle is selected, the application being a program that is fully functional in a full application mode and is less than fully functional in a screen saver mode, the application creating images for presentation on the display screen in the screen saver mode;
a different computer application stored in the memory having at least one different handle executing the different application in a different screen saver mode when the at least one different handle is selected;
rules within the database for determining the scheduling for selecting the at least one handle;
parameters within the database associated with the at least one handle for controlling operational aspects of the application;
a screen saver program stored in the memory selecting the at least one application handle during operation of the screen saver program according to the rules; and
a processor coupled to the memory that performs the steps of:
monitoring the device for detecting inputs from the command entry device;
determining whether a timeout period of inactivity from the inputs has been exceeded;
in accordance with instructions from the screen saver program, selecting the at least one application handle stored in the carousel;
if a signal is not detected from the command entry device since the period of inactivity was exceeded, and if a timeout period for operation of the application is exceeded, selecting the different handle to execute the different application associated with the different handle in its respective different screen saver mode;
if a signal is detected from the command entry device since the period of inactivity was exceeded, determining whether the executed application operating in the screen saver mode is an interactive application; and
if the executed application is interactive,
terminating the screen saver program, and
executing the executed interactive program in a full application mode.
